(19) United States
(12) Patent Application Publication
(10) Pub. No.: US 2014/0342106 A1
(43) Pub. Date: Nov. 20, 2014

(54) Reinforcing and shape-fixing structure for sheet material product

(71) Applicant: Chan-Lin WU, Daly City, CA (US)

(72) Inventor: Chan-Lin WU, Daly City, CA (US)

(21) Appl. No.: 13/894,781

(22) Filed: May 15, 2013

(51) Int. Cl. B32B 7/04

(52) U.S. Cl. CPC B32B 7/045
USPC 428/34.1

(57) ABSTRACT

The present invention provides a reinforcing and shape-fixing structure for a sheet material product, especially for maintain the configuration and reinforcing the structure of various products made of a light and thin sheet material. When the product is shaped, an opened end edge thereof is formed with a preset amount of though holes, so when the end edge of the product is sleeved with a plastic frame having the same configuration, when the two lateral sheets of the frame is processed with a thermal pressing operation, the material of which the two lateral sheets are made can pass the through holes thereby being integrated with each other; thus, the plastic frame can provide the shape-fixing and structure reinforcing effect to the configuration of the product, and also provides a function of changing the combination of colors.

### BACKGROUND OF THE INVENTION

1. Field of the Invention

The present invention relates to an reinforcing and shape-fixing structure for a sheet material product, in which a plastic frame is adopted as a shape-fixing component for the sheet material product, and an end edge of the sheet material is formed with through holes, so after the plastic frame is sleeved with the end edge of the product, a thermal pressing operation is processed for allowing the material of which the plastic frame is made to pass the through holes thereby being integrated with each other, so a firmly combining effect is obtained.

2. Description of Related Art

A stationary or other items used in an office such as a storage box, file folder, pen holder or trash bin is fabricated through plastic injection molding or adopting a rigid material such as a metal sheet or grid net, thereby being able to maintain the structural configuration, the mentioned art can provide a better structural strength and effectively maintain its function, but the material cost is relatively higher; for the severe market competition which has almost led to an era with very little profit zone, manufacturers are all devoting themselves for competing and gaining more market shares.

In order to lower the material cost for this certain type of product, the manufacturers try to find or develop new materials, wherein some manufacturers attempt to use the light and thin sheet material which has a lower price to replace the structure formed through plastic injection molding or punching or folding the metal sheet or grid net so as to make the whole structure thinner, and also make the whole weight lighter, thereby effectively reducing the cost for material, transportation and storage; however, fabricating the product by adopting the light and thin sheet material would cause the whole structure not having enough strength, and the structural configuration is therefore hard to be fixed. In view of the mentioned disadvantages, the present invention provides a reinforcing and shape-fixing structure for a sheet material product.

### SUMMARY OF THE INVENTION

In order to allow a light and thin sheet material to be fabricated to a product such as a storage box, file bolder or pen holder, the aim of the present invention is to maintain the structural configuration after the product made of the light and thin sheet material being formed, thereby increasing the whole structural strength and being more applicable in industries.

In view of the disadvantage that the thickness of a product made of a light and thin sheet material being overly thin and causing the structural configuration being hard to maintained when subject to an external force, the present invention adopts a plastic frame mated with the end edge of a product, by being sleeved with the plastic frame, the structural strength of the product can be reinforced and a shape-fixing effect is also provided, and in order to firmly combine the plastic frame and the sheet material made of different material, through holes are formed close to the end edge of the sheet material thereby allowing the melted material of which the plastic frame is made to pass so as to be integrated with each other.

The reinforcing and shape-fixing structure for a sheet material product provided by the present invention adopts a plastic frame to be sleeved with an end edge of a sheet material product thereby being able to stably maintain the configuration of the product, so the light and thin sheet material can be used for replacing the conventional material for being applied in industries, and saving the cost of material, storage and transportation; moreover, with the colors provided to the plastic frame, the whole outlook can be varied by changing the combination of colors, thereby the quality and outlook of the whole product being enhanced.

### BRIEF DESCRIPTION OF THE DRAWINGS

FIG. 1 is an exploded view showing the structure according to a first preferred embodiment of the present invention;

FIG. 2 is a schematic view showing the structure according to the first preferred embodiment of the present invention;

FIG. 3 is a schematic view illustrating the structural relation according to the first preferred embodiment of the present invention;

FIG. 4 is an exploded view showing the structure according to a second preferred embodiment of the present invention;

FIG. 5 is a schematic view showing the structure according to the second preferred embodiment of the present invention;

FIG. 6 is a schematic view illustrating the structural relation according to the second preferred embodiment of the present invention;

FIG. 7 is a schematic view showing the structure according to a third preferred embodiment of the present invention;

FIG. 8 is a schematic view showing the structure according to a fourth preferred embodiment of the present invention; and

FIG. 9 is a schematic view illustrating the structural relation according to the fourth preferred embodiment of the present invention.

### DESCRIPTION OF MAIN COMPONENT SYMBOLS

10 sheet material product
11 end port
12 end edge
13 through hole
20 plastic frame
21 mount slot
22 lateral sheet
30 sheet material product
31 end port
32 through hole
40 plastic frame
41 mount slot
50 sheet material product
51 end port
52 through hole
60 plastic frame
61 mount slot
62 protrusions

### DETAILED DESCRIPTION OF THE PREFERRED EMBODIMENT

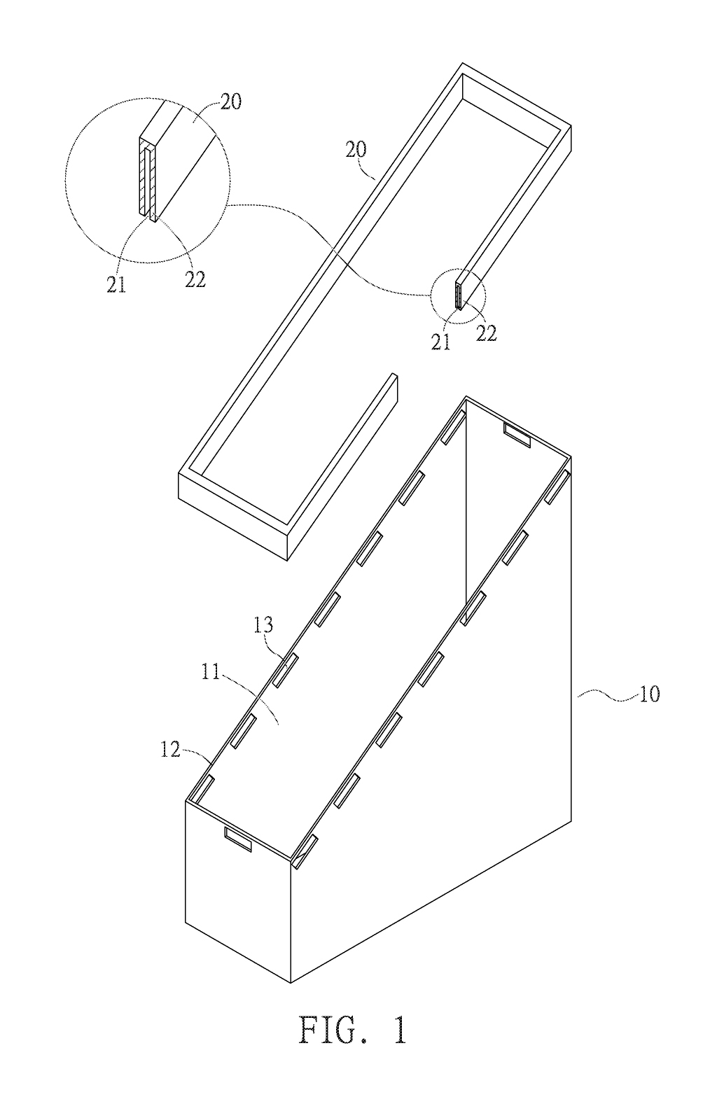

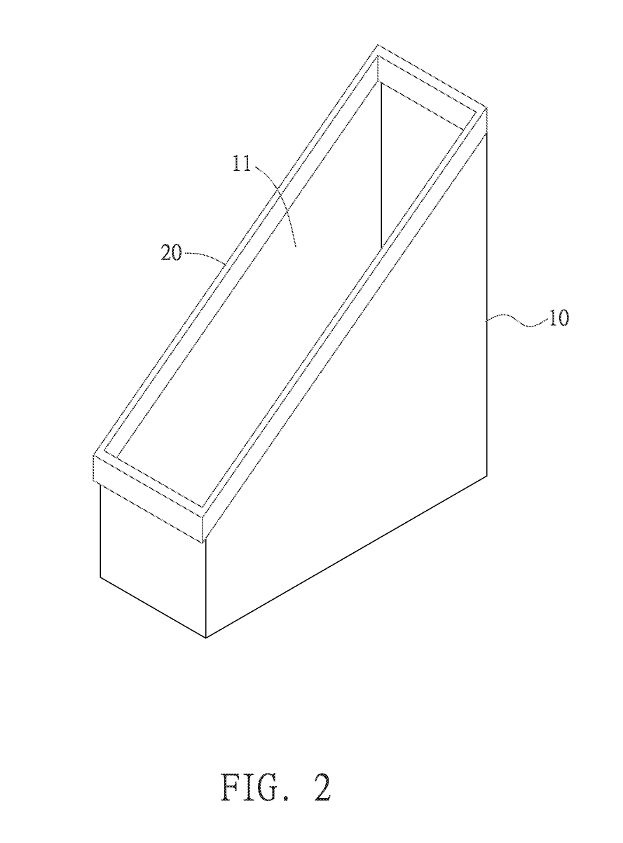

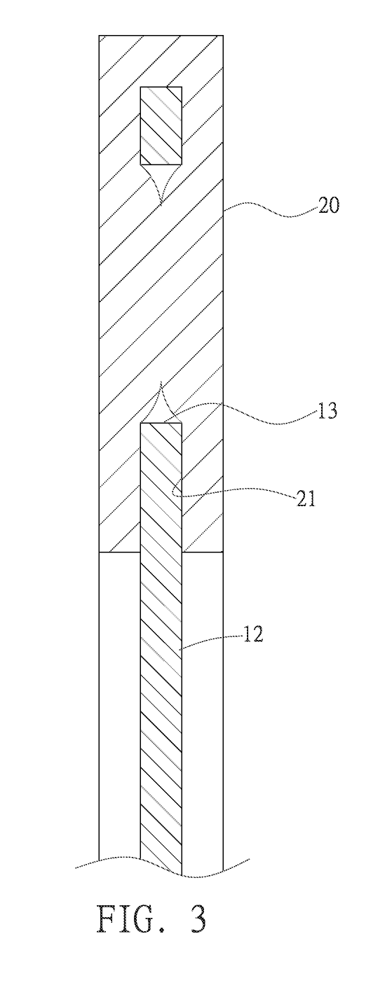

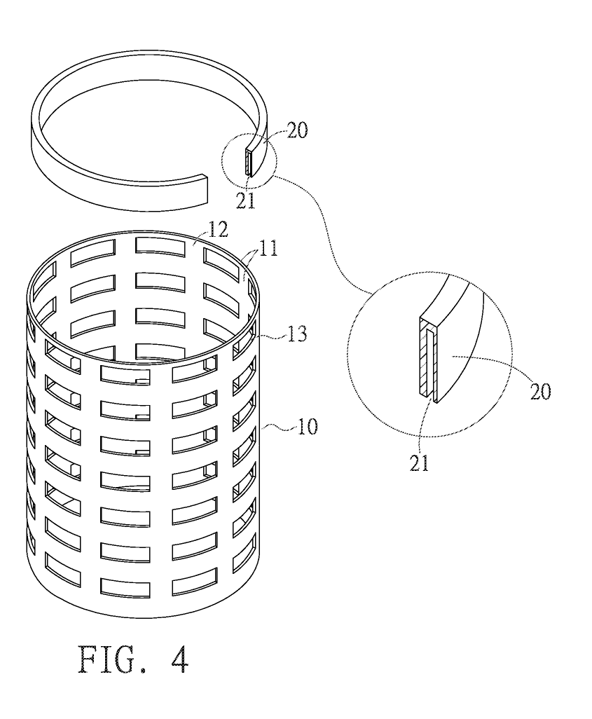

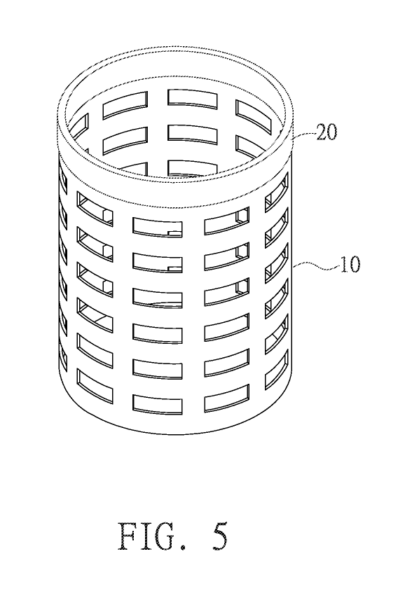

Referring from FIG. 1 to FIG. 5, wherein FIG. 1 is an exploded view showing the structure according to a first preferred embodiment of the present invention; FIG. 2 is a schematic view showing the structure according to the first preferred embodiment of the present invention; FIG. 3 is a schematic view illustrating the structural relation according to the first preferred embodiment of the present invention; FIG. 4 is an exploded view showing the structure according to a second preferred embodiment of the present invention; and FIG. 5 is a schematic view showing the structure according to the second preferred embodiment of the present invention. As shown in figures, the structural design mainly adopts a light and thin sheet material (e.g. a paper sheet, PP sheet, plastic sheet, metal sheet or net sheet) which is punched or folded or assembled to a sheet material product (10) having a preset configuration (e.g. a product for storing or accommodating such as a storage box, file folder, pen holder, trash bin). The sheet material product (10) is formed with at least an end port (11) allowing objects to be entered from, the end port (11) can be formed in a sealed contour status or semi-sealed contour status so as to formed an opened end edge (12), and a proper location of a lateral sheet of the sheet material product (10) close to the end edge (12) is formed with a preset amount of through holes (13) with respect to the contour of the end port (11), and a plastic frame (20) having the same configuration relative to the end port (11) of the sheet material product (10) is formed, the bottom end of the plastic frame (20) is formed with a mount slot (21) having a dimension corresponding to the configuration and thickness of the end port (11) of the sheet material product (10), and the depth of the mount slot (21) is at least greater than the distance defined from the end edge (12) of the sheet material product (10) to the bottom edge of the through hole (13), so when the plastic frame (20) is sleeved with the end port (11) of the sheet material product (10), two lateral sheets (22) of the plastic frame (20) are enabled to fully cover and shield the through holes (13), and when the two lateral sheets (22) of the plastic frame (20) is processed with a thermal pressing operation through high frequency or ultrasonic, the material of which the two lateral sheets (22) are made can be melted for passing the through holes (13) thereby being integrated with each other, so the plastic frame (20) is enabled to be firmly sleeved with the end edge (12) of the end port (11) of the sheet material product (10), so the plastic frame (20) provides a shape-fixing and structure reinforcing effect to the configuration of the sheet material product (10), and with the colors provided to the plastic frame (20), the whole outlook can be varied by changing the combination of colors, thereby the quality and outlook of the whole product being enhanced.

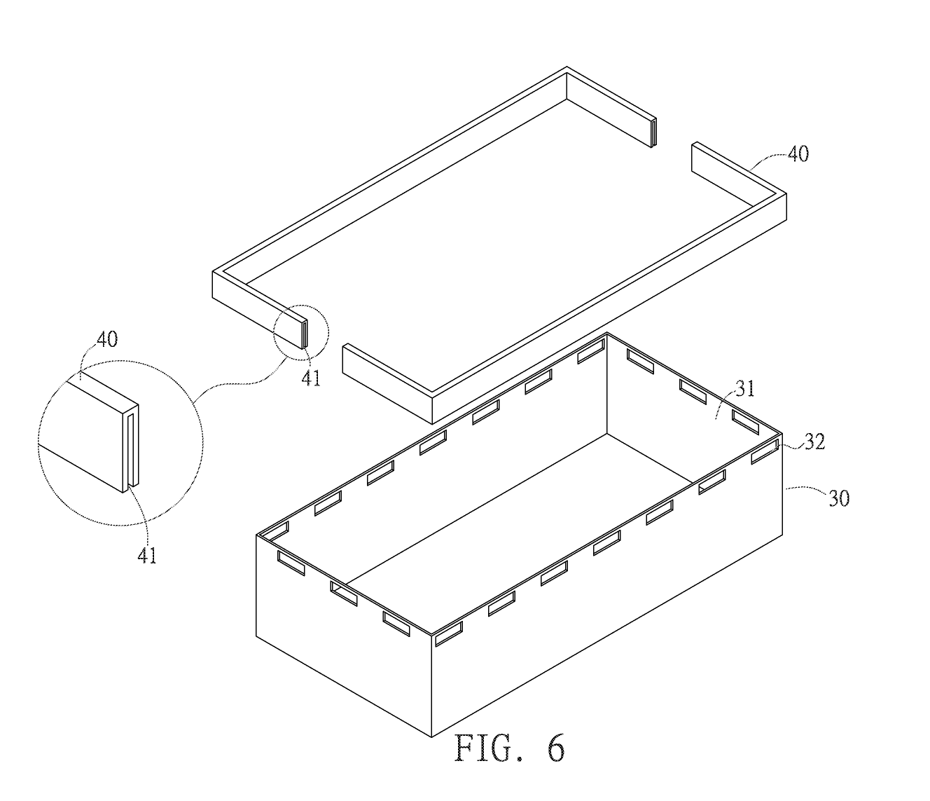

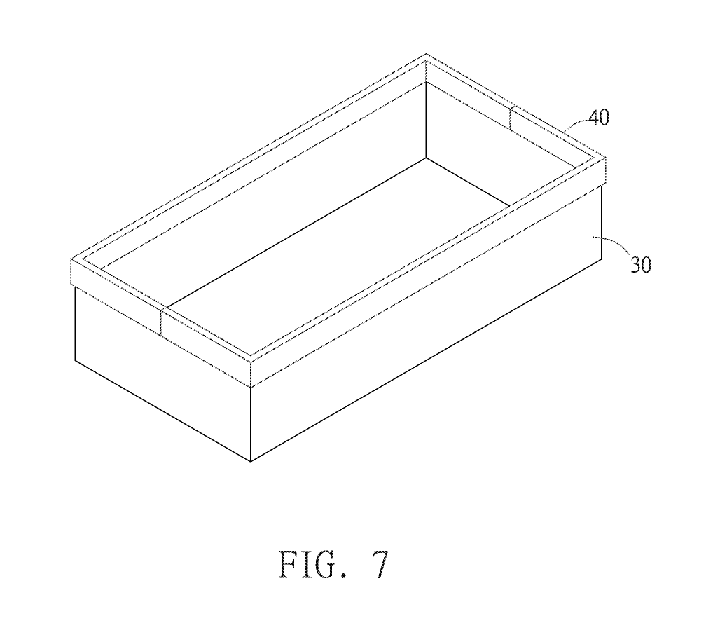

Referring to FIG. 6 and FIG. 7, wherein FIG. 6 is a schematic view illustrating the structural relation according to the second preferred embodiment of the present invention; and FIG. 7 is a schematic view showing the structure according to a third preferred embodiment of the present invention. As shown in figures, a light and thin sheet material is fabricated or assembled for forming a sheet material product (30), and a preset amount of through holes (32) are formed close to an end edge of an end port (31), the through holes (32) can be additionally formed or formed by slits of the sheet material itself, and a plastic frame (40) used for being sleeved with the end edge of the end port (31) of the sheet material product (30) can be formed through assembling two or more pieces, so the molding fabrication can be simplified, the bottom end of the plastic frame (40) is formed with a mount slot (41) capable of being sleeved with the end port (31) and the sheet material product (30), so when the plastic frame (40) is processed with a thermal pressing operation, the material of which the plastic frame (40) is made can be melted for passing the through holes (32) thereby being integrated with each other, so as to provide a shape-fixing and structure reinforcing effect to the sheet material product (30).

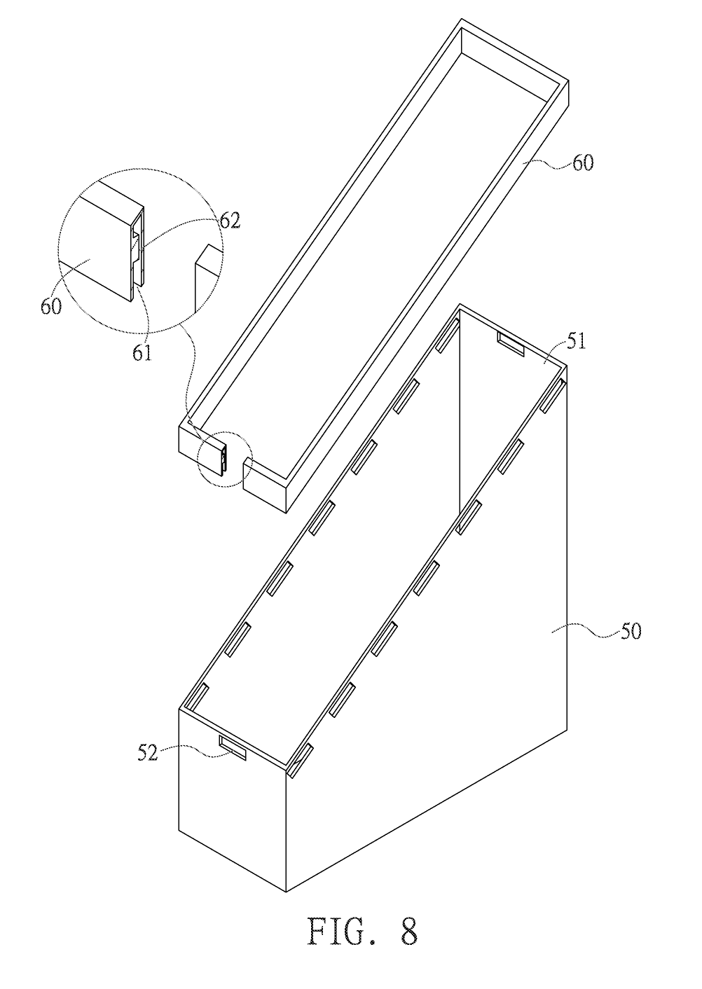

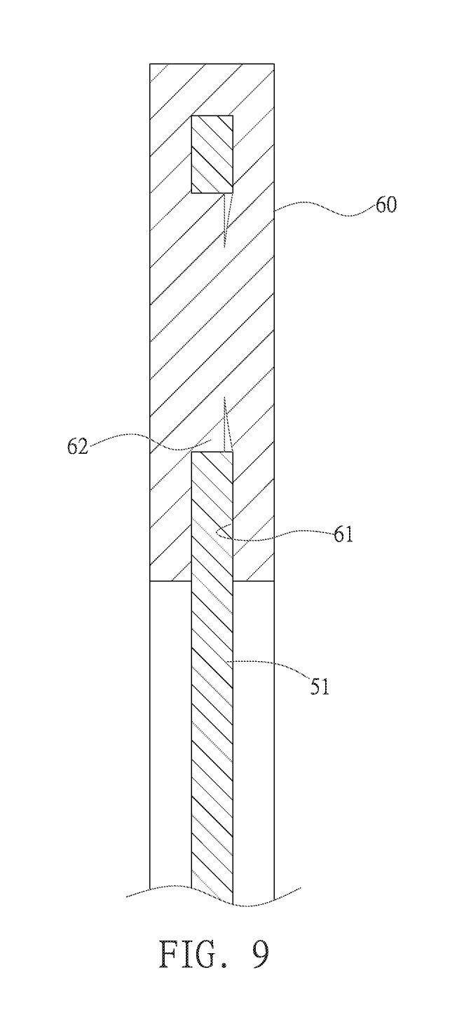

Referring to FIG. 8 and FIG. 9, which is FIG. 8 is a schematic view showing the structure according to a fourth preferred embodiment of the present invention; and FIG. 9 is a schematic view illustrating the structural relation according to the fourth preferred embodiment of the present invention. As shown in figures, in order to maintain and reinforce the structural configuration of the light and thin sheet material product, the present invention utilizes a plastic frame which is separately made for being sleeved with the end port of the sheet material product, and a thermal pressing operation is processed for firmly combining the above two, so the light and thin sheet material can be used for replacing the conventional sheet material for being fabricated to various products; and for the maintain shape of a sheet material product (50) made of a thicker sheet material, an end edge of an end port (51) is formed with through holes (52), the inner edge of a mount slot (61) of a plastic frame (60) is further formed with protrusions (62) on at least one lateral wall (or two lateral walls) at the locations corresponding to the through holes (52), so two lateral sheets of the plastic frame (60) can be in contact through the protrusions (62) passing the through holes (52), so when the plastic frame (60) is processed with a thermal pressing operation, a melting combination effect can be obtained for ensuring the shape-fixing and structure reinforcing effect provided by the plastic frame (60) to the sheet material product (50).

As what has been disclosed above, the present invention adopts a light and thin sheet material for replacing the conventional material which is thicker in thickness for being fabricated to various products for storing, and the plastic frame which is separately formed is sleeved with the end edge of the end port of the sheet material product, and the end edge is formed with a preset amount of through holes, so the material of which the plastic frame is made can be melted for passing the through holes thereby being integrated with each other and separation is also prevented, so the structural configuration of the sheet material product can be provided with the shape-fixing and reinforcing effect, the light and thin sheet material is able to be adopted for being fabricated to various products for storing, so the present invention is novel and practical in use.

Accordingly, the reinforcing and shape-fixing structure for the sheet material product provided by the present invention can effectively provide the shape-fixing and reinforcing effect to the sheet material product, so the sheet material product is prevented from being deformed or damaged due to a small external force, so various products made of the light and thin sheet material are applicable in many industries.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A reinforcing and shape-fixing structure for a sheet material product, the mentioned sheet material product is made of a light and thin sheet material, at least an end port allowing objects to be entered is formed, the end port is formed in a sealed contour status or semi-sealed contour status so as to formed an opened end edge; characterized in that:
a preset location of a lateral sheet of the sheet material product close to the end edge is formed with a preset amount of through holes with respect to the contour of the end port, and a plastic frame having the same configuration relative to the end port of the sheet material product is formed, the bottom end of the plastic frame is formed with a mount slot having a dimension corresponding to the configuration and thickness of the end port of the sheet material product, when the plastic frame is sleeved with the end port of the sheet material product, two lateral sheets of the plastic frame are enabled to fully cover and shield the through holes, and when the two lateral sheets of the plastic frame is processed with a thermal pressing operation, the material of which the two lateral sheets are made is melted for passing the through holes thereby being integrated with each other.

2. The reinforcing and shape-fixing structure for a sheet material product according to claim 1, wherein the depth of the mount slot of the plastic frame is at least greater than the distance defined from the end edge of the sheet material product to the bottom edge of the through hole.

3. The reinforcing and shape-fixing structure for a sheet material product according to claim 1, wherein the inner walls of plural locations of the mount slot of the plastic frame corresponding to the though holes of the sheet material product are respectively formed with a protrusion capable of passing the through hole for being in contact with the other inner wall.

4. The reinforcing and shape-fixing structure for a sheet material product according to claim 1, wherein the through holes of the sheet material product are additionally formed.

5. The reinforcing and shape-fixing structure for a sheet material product according to claim 1, wherein the through holes of the sheet material product are formed by the sheet material itself.

6. The reinforcing and shape-fixing structure for a sheet material product according to claim 1, wherein the plastic frame is formed through assembling plural pieces.
